(19) United States
(12) Patent Application Publication
(10) Pub. No.: US 2020/0242909 A1
(43) Pub. Date: Jul. 30, 2020

(54) Physiological-Based Detection of Event

(71) Applicant: Securus Technologies, Inc., Dallas, TX (US)

(72) Inventor: Luke Keiser, Frisco, TX (US)

(73) Assignee: Securus Technologies, Inc., Dallas, TX (US)

(21) Appl. No.: 15/078,157

(22) Filed: Mar. 23, 2016

(51) Int. Cl. G08B 21/18

(52) U.S. Cl. CPC G08B 21/18

(57) ABSTRACT

Systems and methods relate to detection of a possible event based on data indicative of one or more physiological indicator(s). In an example embodiment, data indicative of multiple physiological indicators of a person is received using an analytics module operating on at least one processor. The data is transmitted from a wearable device worn by the person. Changes in at least two of the multiple physiological indicators are detected from the data using the analytics module. An occurrence of a possible event is determined based on the changes in the at least two of the multiple physiological indicators using the analytics module. The determining of the occurrence of the possible event comprises correlating the changes in the at least two of the multiple physiological indicators to pre-defined combinations of changes in corresponding physiological indicators. An alert is transmitted using the analytics module when the occurrence of the possible event is determined.

### TECHNICAL FIELD

The present disclosure relates generally detecting a possible event based on data indicative of one or more physiological indicator(s).

### BACKGROUND

Correctional officers are generally tasked with overseeing inmates' daily tasks and conduct. For example, correctional officers generally supervise activities of inmates and enforce rules to keep order within jails or prisons. Correctional officers also typically search inmates for contraband and report on inmate conduct. These tasks can be difficult for a correctional officer since each correctional officer may oversee many inmates.

With each correctional officer overseeing many inmates, it may be difficult for the correctional officer to adequately supervise each inmate's conduct. Hence, inmates may be able to engage in detrimental or illicit conduct without the correctional officer's detection. Hence, prison fights can escalate into difficult to control magnitudes; illicit communications may occur; and the like. Further, without a correctional officer's detection, there may not be a reliable witness or evidentiary source for correcting or prosecuting detrimental or illicit activities that occur.

### SUMMARY

The present disclosure is directed to systems and methods which detect a possible event based on data indicative of one or more physiological indicator(s). The detection of a possible event may allow for earlier detection of an event than what may have been possible previously. This may allow for intervention in a situation before an event occurs or before an event escalates to a magnitude that is difficult to control. Further, data can be stored and tagged with changes in one or more physiological indicator(s) and/or a possible event. This information can be subsequently used to more efficiently investigate matters or to provide for more effective data mining.

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processor, wherein the memory is configured to store program instructions executable by the processor to cause the system(s) to execute one or more operations disclosed herein.

An embodiment is a method. Data indicative of multiple physiological indicators of a person is received using an analytics module operating on at least one processor. The data is transmitted from a wearable device worn by the person. Changes in at least two of the multiple physiological indicators are detected from the data using the analytics module. An occurrence of a possible event is determined based on the changes in the at least two of the multiple physiological indicators using the analytics module. The determining the occurrence of the possible event comprises correlating the changes in the at least two of the multiple physiological indicators to pre-defined combinations of changes in corresponding physiological indicators. An alert is transmitted using the analytics module when the occurrence of the possible event is determined.

Another embodiment is a system. The system includes a wearable device, a wireless access point, and an analytics server device. The wearable device has sensor devices. The wearable device and sensor devices are operable to generate data indicative of multiple physiological indicators of a person wearing the wearable device. The wearable device further comprises a first wireless communication component operable to wirelessly transmit a signal comprising the data. The wireless access point comprises a second wireless communication component operable to receive the signal. The analytics server device is communicatively coupled to the wireless access point. The analytics server device comprises an analytics module operable on at least one processor. The analytics module is operable to receive the data, to detect changes in the multiple physiological indicators of the person from the data, and to determine an occurrence of a possible event based on the changes in the multiple physiological indicators.

A further embodiment is a non-transitory computer-readable storage medium having a computer program embodied thereon. The computer program comprises program code instructions for receiving first data generated from a wearable device worn by a first person, the first data being indicative of physiological indicators of the first person; program code instructions for detecting changes in the physiological indicators based on the first data; program code instructions for determining when the changes in the physiological indicators indicate an occurrence of a possible event; and program code instructions for generating and transmitting an alert when the occurrence of the possible event is indicated.

The foregoing has outlined rather broadly the features and technical advantages of the present embodiments in order that the detailed description that follows may be better understood. Additional features and advantages will be described hereinafter which form the subject of the claims of the invention. It should be appreciated that the conception and specific embodiments disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described some embodiments in general terms, reference will now be made to the accompanying drawings, which are not necessarily drawn to scale, and wherein:

FIG. 1 is a diagrammatic illustration of an example detecting environment in accordance with some embodiments.

FIG. 2 is a flowchart of a first example implementation of a process for detecting a possible event in accordance with some embodiments.

FIG. 3 is an example process for a detecting change in a physiological indicator in accordance with some embodiments.

FIG. 4 is an example list defining combinations of changes of physiological indicators as indicative of potential events in accordance with some embodiments.

FIG. 5 is a flowchart of a second example implementation of a process for detecting a possible event in accordance with some embodiments of the present systems and methods.

FIG. 6 is a flowchart of a third example implementation of a process for detecting a possible event in accordance with some embodiments of the present systems and methods.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

Some embodiments now will be described more fully hereinafter with reference to the accompanying drawings. Embodiments may take many different forms and should not be construed as limited to the disclosure set forth herein. Rather, these embodiments herein are provided so that this disclosure will be thorough and complete, and will fully convey the scope of the invention to those skilled in the art. One skilled in the art may be able to use the various embodiments of the invention.

Some embodiments described herein relate generally to detecting a possible event based on one or more change(s) in one or more physiological indicators of a resident in a controlled-environment facility, and potentially, to dispatching one or more authorized personnel in response to the detection of a possible event. Some embodiments are described with reference to a controlled-environment facility. However, other embodiments can be applied in any environment. The detecting of a possible event based on physiological indicators can allow for earlier responses to events, such as before an event occurs or escalates to a magnitude that may be difficult to control. Additionally, an earlier response to an event by an authorized personnel (e.g., a correctional officer) may allow for a more credible and reliable person to witness the event.

An event can be, and commonly is, precipitated by a change in an emotional state of a participant to that event when that event may be prohibited or illicit, for example. A person about to engage in or engaging in an illicit transaction may become anxious or fearful of being observed by authorized personnel. A person about to engage in or engaging in a confrontation may become excited, anxious, fearful, etc. These changes in emotional state can result in changes in physiological indicators, such as respiratory rate, blood pressure, heart rate, body temperature, etc. For example, a person that is about to engage in a confrontation may have an increased heart rate and body temperature. Accordingly, changes in physiological indicators can be detected to determine if an event is about to occur or is occurring.

Various types of controlled-environment facilities are present in today's society, and persons may be voluntary or involuntary residents of such facilities, whether temporarily or permanently. Examples of controlled-environment facilities may include correctional institutions (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation facilities, such as drug and alcohol rehabilitation facilities, etc.), restricted living quarters (e.g., hotels, resorts, camps, dormitories, barracks, etc.), and the like. For convenience of explanation, various examples discussed herein are presented in the context of correctional facilities, or the like. For instance, in some of the embodiments discussed below, an example of a controlled-environment facility may be a correctional facility, jail, or prison, and its residents may be referred to as inmates, arrestees, or detainees. It should be understood, however, that the systems and methods described herein may be similarly applicable to other types of controlled-environment facilities and their respective residents (e.g., a hospital and its patients, a school dormitory and its students, etc.).

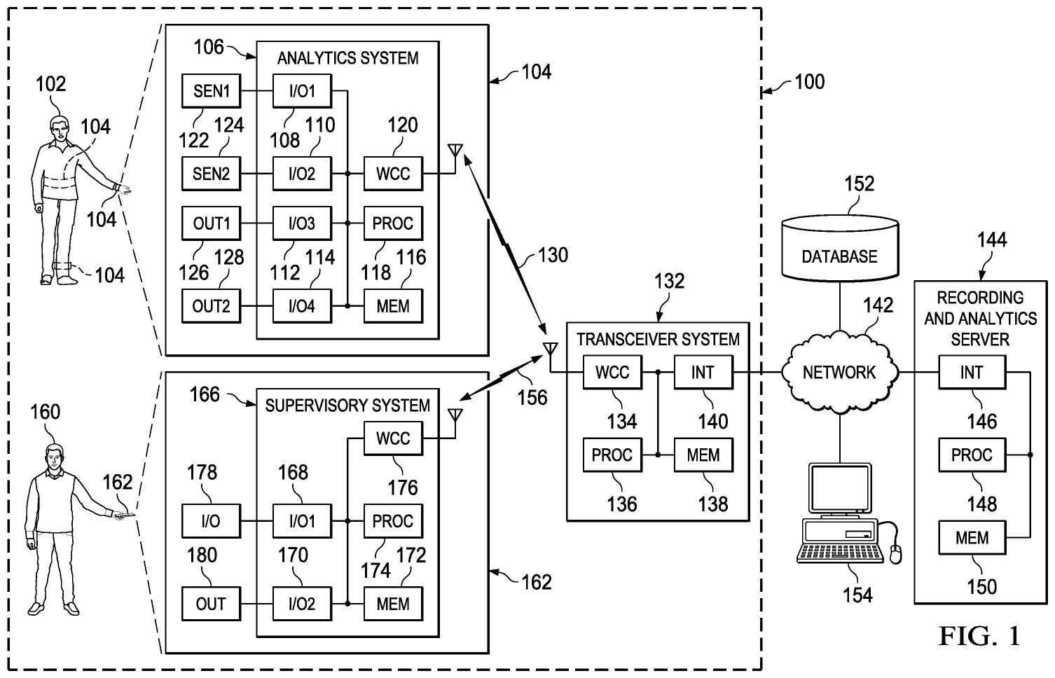

FIG. 1 is a diagrammatic illustration of an example detecting environment in accordance with some embodiments. The illustration shows a controlled-environment facility 100, which may be a correctional facility like a jail or prison. A first person 102 is shown within the controlled-environment facility 100. The first person 102 may be a resident (e.g., inmate) of the controlled-environment facility 100.

The first person 102 is wearing a wearable device 104. The wearable device 104 can monitor physiological indicators and can output or transmit various data or indications. As illustrated, the wearable device 104 is worn on the wrist of the first person 102, such as a bracelet. In other examples, the wearable device 104 can be worn around the chest, torso, waist, ankle, etc. of the first person 102, and further, the wearable device 104 can be sewn into clothing worn by the first person 102, such as in a waistband, collar, sleeve, or the like.

The wearable device 104 includes an analytics system 106, which may be referred to as a computing system, that includes a first input/output (I/O) interface 108, a second I/O interface 110, a third I/O interface 112, a fourth I/O interface 114, memory 116, one or more processor(s) 118, and a wireless communication component 120, which are communicatively coupled together, for example, through a bus in the analytics system 106. The illustrated implementation of the analytics system 106 is an example, and additional or fewer components may be included. Further, functionalities of various components of the analytics system 106 as discussed herein can be distributed across different components within or outside of the analytics system 106.

The wearable device 104 further includes a first sensor device 122, a second sensor device 124, a first output device 126, and a second output device 128. The first sensor device 122 and the second sensor device 124 can obtain or generate data that is indicative of one or more physiological indicators. The first output device 126 and second output device 128 can provide various output indications, such as by visual indications, audio indications, haptic indications, or the like. The first sensor device 122 is communicatively coupled to the first I/O interface 108. The second sensor device 124 is communicatively coupled to the second I/O interface 110. The first output device 126 is communicatively coupled to the third I/O interface 112. The second output device 128 is communicatively coupled to the fourth I/O interface 114.

As illustrated, the first sensor device 122, second sensor device 124, first output device 126, and second output device 128 are within the wearable device 104 and are coupled to the respective I/O interfaces 108, 110, 112, and 114 using wired connections. In other examples, any or all of the first sensor device 122, second sensor device 124, first output device 126, and second output device 128 can be separate from the wearable device 104 and can be communicatively coupled to the respective I/O interfaces 108, 110, 112, and 114 or wireless communication components using wired connections or wireless communication, such as Bluetooth communication. For example, the first sensor device 122 can be a respiratory monitor worn around the chest of the first person 102, and the first sensor device 122 can communicate wirelessly to the analytics system 106 using Bluetooth communication to a wireless communication component (e.g., not shown, and which can be used in the place of the first I/O interface 108). Any number of sensor devices and output devices, and thus, any number of I/O interfaces and/or wireless communication components, may be used in and/or with the wearable device 104.

In some embodiments, I/O interfaces 108, 110, 112 and 114 may each be configured to coordinate I/O traffic between processor 118, memory 116, and any peripheral devices in or communicatively coupled to the wearable device 104, including wireless communication component 120 or other peripheral interfaces. I/O interfaces 108, 110, 112 and 114 may each perform any suitable protocol, timing or other data transformations to convert data signals from one component (e.g., first sensor device 122 and second sensor device 124) into a format usable by another component (e.g., processor 118). I/O interfaces 108, 110, 112 and 114 may include support for devices attached through various types of peripheral buses, such as a variant of the Peripheral Component Interconnect (PCI) bus standard or the Universal Serial Bus (USB) standard, for example. In some embodiments, the function of I/O interfaces 108, 110, 112 and 114 may be split into two or more separate components, such as a north bridge and a south bridge, for example. In addition, some or all of the functionality of I/O interfaces 108, 110, 112 and 114, such as an interface to memory 116, may be incorporated into processor 118.

In various embodiments, the analytics system 106 may be a single-processor system including one processor 118, or a multi-processor system including two or more processors 118 (e.g., two, four, eight, or another suitable number). Processor 118 may be any processor capable of executing program instructions. For example, in various embodiments, processor 118 may be a general-purpose or embedded processor implementing any of a variety of instruction set architectures (ISAs), such as the x86, POWERPC®, ARM®, SPARC®, or MIPS® ISAs, or any other suitable ISA. In multi-processor systems, each of processors 118 may commonly, but not necessarily, implement the same ISA.

Memory 116 may be configured to store program instructions and/or data accessible by processor 118. In various embodiments, memory 116 may be implemented using any suitable tangible or non-transitory storage memory, such as static random access memory (SRAM), synchronous dynamic RAM (SDRAM), nonvolatile/Flash-type memory, or any other type of memory. As illustrated, program instructions and data implementing certain operations, such as, for example, those described below, may be stored within memory 116 as program instructions and data storage, respectively. In other embodiments, program instructions and/or data may be received, sent or stored upon different types of computer-accessible media or on similar media separate from memory 116 or the analytics system 106. Generally speaking, a computer-readable medium may include any tangible or non-transitory storage media or memory media such as Flash memory, random access memory (RAM), etc. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via the wireless communication component 120.

The analytics system 106 can operate an analytics module on the processor 118. The analytics module may include program code instructions stored on the memory 116 or other tangible, non-transitory memory that when operated on the processor 118 performs one or more specific tasks, such as tasks described below. The analytics module may include additional sub-modules and/or one or more routines. In some embodiments, the analytics module may be part of a single program, routine, function, or the like, or may be separate programs, routines, functions or the like.

The wireless communication component 120 can be any component that enables wireless communication with, e.g., a transceiver system 132. For example, the wireless communication component 120 can be circuitry (including an antenna) that implements communication using Wi-Fi communication, Bluetooth communication, or the like.

The first sensor device 122 and the second sensor device 124 can be any device for generating and capturing data for monitoring one or more physiological indicators of the first person 102. Some physiological indicators include respiratory rate, heart rate, blood pressure, body temperature, voice volume level, speaking rate, voice frequency, or the like. As examples, a sensor device to capture data for respiratory rate includes respiratory electrodes on the first person 102, such as a BioPatch™ available from Zephyr Technology Corporation; a harness worn around the chest of the first person 102 such as a BioHarness™ available from Zephyr Technology Corporation; textile sensors that are integrated into the clothing of the first person 102, such as Textro-Sensors®, Textro-Yarns®, Textro-Polymers®, and Textro-Interconnects® available from Textronics, Inc.; or the like. An example sensor device to capture data for heart rate includes a MAX30100 available from Maxim Integrated Products, Inc. or the like. An example sensor device to capture data for blood pressure includes a sensor device similar to what is utilized in the “H2” blood pressure monitor by CharmCare, Co., Ltd. An example sensor device to capture data for body temperature includes any thermometer like those available in many applications, such as in the Microsoft Band available from Microsoft, Inc. An example sensor device to capture data voice volume level, speaking rate, and voice frequency can be any acceptable microphone. Although a first sensor device 122 and a second sensor device 124 are illustrated in FIG. 1, any number of sensor devices can be incorporated into and/or used with the wearable device 104—for example, the wearable device 104 can have a respiratory rate sensor device, a heart rate sensor device, a blood pressure sensor device, a body temperature sensor device, and a microphone sensor device.

The first output device 126 and the second output device 128 can be any device for providing sensory indications to the first person 102. The sensory indications can include visual, auditory, haptic, or the like. As an example, an output device to provide a visual indication can include one or more light emitting diode (LED) (e.g., for simple discrete indications), a liquid crystal display (LCD), an organic LED (OLED) display, or the like. As another example, an output device to provide an auditory indication can be a speaker or the like. In an example, an output device to provide a haptic indication can include a piezoelectric vibration generator, a vibration motor, or the like. Although a first output device 126 and a second output device 128 are illustrated in FIG. 1, any number of output devices can be incorporated into and/or used with the wearable device 104—for example, the wearable device 104 can have a display output device, a vibration output device, and a speaker output device.

The controlled-environment facility 100 further includes the transceiver system 132. As illustrated, the transceiver system 132, which may be referred to as a computing system, includes a wireless communication component 134, one or more processor(s) 136, memory 138, and a network interface card 140 coupled together, e.g., through a bus. The transceiver system 132 may be referred to as a wireless access point (WAP). The illustrated implementation of the transceiver system 132 is an example, and additional or fewer components may be included. Further, functionalities of various components of the transceiver system 132 as discussed herein can be distributed across different components within or outside of the transceiver system 132.

The wireless communication component 134 can be any component that enables wireless communication with, e.g., the wireless communication component 120 of the wearable device 104. For example, the wireless communication component 134 can be circuitry (including an antenna) that implements communication using Wi-Fi communication, Bluetooth communication, or the like.

In various embodiments, the transceiver system 132 may be a single-processor system including one processor 136, or a multi-processor system including two or more processors 136 (e.g., two, four, eight, or another suitable number). Processor 136 may be any processor capable of executing program instructions. For example, in various embodiments, processor 136 may be a general-purpose or embedded processor implementing any of a variety of ISAs, such as the x86, POWERPC®, ARM®, SPARC®, or MIPS® ISAs, or any other suitable ISA. In multi-processor systems, each of processors 136 may commonly, but not necessarily, implement the same ISA.

Memory 138 may be configured to store program instructions and/or data accessible by processor 136. In various embodiments, memory 138 may be implemented using any suitable tangible or non-transitory storage memory, such as SRAM, SDRAM, nonvolatile/Flash-type memory, or any other type of memory. As illustrated, program instructions and data implementing certain operations, such as, for example, those described below, may be stored within memory 138 as program instructions and data storage, respectively. In other embodiments, program instructions and/or data may be received, sent or stored upon different types of computer-accessible media or on similar media separate from memory 138 or the transceiver system 132. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via the network interface card 140.

The transceiver system 132 can operate a transmission module on the processor 136. The transmission module may include program code instructions stored on the memory 138 or other tangible, non-transitory memory that when operated on the processor 136 performs one or more specific tasks, such as tasks described below. The transmission module may each include additional sub-modules and/or one or more routines. In some embodiments, the transmission module may be part of a single program, routine, function, or the like, or may be separate programs, routines, functions or the like.

Network interface card 140 may be configured to allow data to be exchanged between the transceiver system 132 and another device directly coupled to the transceiver system 132, or between the transceiver system 132 and other devices attached to a network 142 (e.g., local area network (LAN), wide area network (WAN), the Internet, or the like), such as other computer systems. In various embodiments, network interface card 140 may support communication via wired or wireless general data networks, such as any suitable type of Ethernet network, for example; via telecommunications/telephony networks such as analog voice networks or digital fiber communications networks; via storage area networks such as Fibre Channel storage-area networks (SAN), or via any other suitable type of network and/or protocol.

A recording and analytics server device 144, which may be referred to as a computing system, is communicatively coupled to the network 142. As illustrated, the recording and analytics server device 144 includes one or more processor(s) 148, memory 150, and a network interface card 146 coupled together, e.g., through a bus. The illustrated implementation of the recording and analytics server device 144 is an example, and additional or fewer components may be included. For example, the recording and analytics server device 144 may include one or more I/O interface coupled to one or more input/output devices or peripherals. Further, functionalities of various components of the recording and analytics server device 144 as discussed herein can be distributed across different components within or outside of the recording and analytics server device 144.

In various embodiments, the recording and analytics server device 144 may be a single-processor system including one processor 148, or a multi-processor system including two or more processors 148 (e.g., two, four, eight, or another suitable number). Processor 148 may be any processor capable of executing program instructions. For example, in various embodiments, processor 148 may be a general-purpose or embedded processor implementing any of a variety of ISAs, such as the x86, POWERPC®, ARM®, SPARC®, or MIPS® ISAs, or any other suitable ISA. In multi-processor systems, each of processors 148 may commonly, but not necessarily, implement the same ISA.

Memory 150 may be configured to store program instructions and/or data accessible by processor 148. In various embodiments, memory 150 may be implemented using any suitable tangible or non-transitory storage memory, such as SRAM, SDRAM, nonvolatile/Flash-type memory, or any other type of memory. As illustrated, program instructions and data implementing certain operations, such as, for example, those described below, may be stored within memory 150 as program instructions and data storage, respectively. In other embodiments, program instructions and/or data may be received, sent or stored upon different types of computer-accessible media or on similar media separate from memory 150 or the recording and analytics server device 144. Generally speaking, a computer-readable medium may include any tangible or non-transitory storage media or memory media such as magnetic or optical media—e.g., disk or CD/DVD-ROM coupled to the recording and analytics server device 144 via an I/O interface(s), Flash memory, RAM, etc. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via the network interface card 146.

The recording and analytics server device 144 can operate a recording module and an analytics module on the processor 148. The recording module and the analytics module may each include program code instructions stored on the memory 150 or other tangible, non-transitory memory that when operated on the processor 148 performs one or more specific tasks, such as tasks described below. The recording module and the analytics module may each include additional sub-modules and/or one or more routines. In some embodiments, the recording module and the analytics module may be part of a single program, routine, function, or the like, or may be separate programs, routines, functions or the like.

Network interface card 146 may be configured to allow data to be exchanged between the recording and analytics server device 144 and another device directly coupled to the recording and analytics server device 144, or between the recording and analytics server device 144 and other devices attached to the network 142, such as other computer systems. In various embodiments, network interface card 146 may support communication via wired or wireless general data networks, such as any suitable type of Ethernet network, for example; via telecommunications/telephony networks such as analog voice networks or digital fiber communications networks; via storage area networks such as Fibre Channel SAN, or via any other suitable type of network and/or protocol.

A database device 152, operating a database with an appropriate database management system (DBMS), is communicatively coupled to the network 142, for example, using one or more network interface card(s) (not specifically shown). The database device 152 can include one or more processor(s) for operating the DBMS, system memory for storing program instructions of the DBMS, and database memory for storing the database. A processor in the database device 152 may be any processor capable of executing program instructions. For example, in various embodiments, the processor may be a general-purpose or embedded processor implementing any of a variety of ISAs, such as the x86, POWERPC®, ARM®, SPARC®, or MIPS® ISAs, or any other suitable ISA. In multi-processor systems, each of processors may commonly, but not necessarily, implement the same ISA. System memory of the database device may be configured to store program instructions and/or data accessible by processor. In various embodiments, system memory may be implemented using any suitable tangible or non-transitory memory medium. Program instructions and data implementing certain operations, such as, for example, the DBMS, may be stored within system memory as program instructions and data storage, respectively. In other embodiments, program instructions and/or data may be received, sent or stored upon different types of computer-accessible media or on similar media separate from system memory or the database device 152. Generally speaking, a computer-readable medium may include any tangible or non-transitory storage media or memory media. The DBMS may be structured query language (SQL)-based, IBM DB2, or the like. The database can be stored in any acceptable memory technology, such as redundant array of independent disks (RAID) or the like.

A terminal 154 is also communicatively coupled to the network 142 by, e.g., a wired and/or wireless connection. The terminal 154 can be, for example, a computer, laptop, tablet, smartphone, or other device that can receive data, such as by querying the database of the database device 152. Connections between the network 142 and the various systems, e.g., the transceiver system 132, recording and analytics server device 144, database device 152, and terminal 154, may be wired connections, wireless connections, or any combination thereof.

A second person 160 is shown within the controlled-environment facility 100. The second person 160 may be an authorized personnel (e.g., correctional officer, guard, or supervisor) of the controlled-environment facility 100. The second person 160 possesses a supervisory device 162, which may be, for example, a smartphone, a tablet, or the like. The supervisory device 162 allows alerts to be sent to the second person 160 and allows the second person 160 to query the database device 152 to check the status of, e.g., the first person 102. Although only a single second person 160 is shown, it will be understood that multiple authorized people may have a supervisory device 162. Likewise, multiple first users 102 may be monitored via the supervisory device(s) 162.

The supervisory device 162 includes a supervisory system 166, which may be referred to as a computing system, that includes a first I/O interface 168, a second I/O interface 170, memory 172, one or more processor(s) 174, and a wireless communication component 176, which are communicatively coupled together, for example, through a bus in the supervisory system 166. The illustrated implementation of the supervisory system 166 is an example, and additional or fewer components may be included. Further, functionalities of various components of the supervisory system 166 as discussed herein can be distributed across different components within or outside of the supervisory system 166.

The supervisory device 162 further includes an I/O device 178 and an output device 180. The I/O device 178 can obtain data through input from, e.g., the second person 160, and provide data and/or indications, e.g., alerts, to the second person 160. The output device 180 can provide various output indications, such as by visual indications, audio indications, haptic indications, or the like. The I/O device 178 is communicatively coupled to the first I/O interface 168. The output device 180 is communicatively coupled to the second I/O interface 170.

As illustrated, the I/O device 178 and the output device 180 are within the supervisory device 162 and are coupled to the respective I/O interfaces 168 and 170 using wired connections. In other examples, any or all of the I/O device 178 and the output device 180 can be separate from the supervisory device 162 and can be communicatively coupled to the respective I/O interfaces 168 and 170 or wireless communication components using wired connections or wireless communication, such as Bluetooth communication. Any number of input devices, output devices, and I/O devices, and thus, any number of I/O interfaces and/or wireless communication components, may be used in and/or with the supervisory device 162.

In some embodiments, I/O interfaces 168 and 170 may each be configured to coordinate I/O traffic between processor 174, memory 172, and any peripheral devices in or communicatively coupled to the supervisory device 162, including wireless communication component 176 or other peripheral interfaces. I/O interfaces 168 and 170 may each perform any suitable protocol, timing or other data transformations to convert data signals from one component (e.g., I/O device 178) into a format usable by another component (e.g., processor 174). I/O interfaces 168 and 170 may include support for devices attached through various types of peripheral buses, such as a variant of the PCI bus standard or the USB standard, for example. In some embodiments, the function of I/O interfaces 168 and 170 may be split into two or more separate components, such as a north bridge and a south bridge, for example. In addition, some or all of the functionality of I/O interfaces 168 and 170, such as an interface to memory 172, may be incorporated into processor 174.

In various embodiments, the supervisory system 166 may be a single-processor system including one processor 174, or a multi-processor system including two or more processors 174 (e.g., two, four, eight, or another suitable number). Processor 174 may be any processor capable of executing program instructions. For example, in various embodiments, processor 174 may be a general-purpose or embedded processor implementing any of a variety of ISAs, such as the x86, POWERPC®, ARM®, SPARC®, or MIPS® ISAs, or any other suitable ISA. In multi-processor systems, each of processors 174 may commonly, but not necessarily, implement the same ISA.

Memory 172 may be configured to store program instructions and/or data accessible by processor 174. In various embodiments, memory 172 may be implemented using any suitable tangible or non-transitory storage memory, such as SRAM, SDRAM, nonvolatile/Flash-type memory, or any other type of memory. As illustrated, program instructions and data implementing certain operations, such as, for example, those described below, may be stored within memory 172 as program instructions and data storage, respectively. In other embodiments, program instructions and/or data may be received, sent or stored upon different types of computer-accessible media or on similar media separate from memory 172 or the supervisory system 166. Generally speaking, a computer-readable medium may include any tangible or non-transitory storage media or memory media such as Flash memory, RAM, etc. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via one or more wireless communication component(s) 176.

The supervisory system 166 can operate a supervisory module on the processor 174. The supervisory module may include program code instructions stored on the memory 172 or other tangible, non-transitory memory that when operated on the processor 174 performs one or more specific tasks, such as tasks described below. The supervisory module may include additional sub-modules and/or one or more routines. In some embodiments, the supervisory module may be part of a single program, routine, function, or the like, or may be separate programs, routines, functions or the like.

The wireless communication component 176 can be any component that enables wireless communication with, e.g., a transceiver system 132. For example, the wireless communication component 120 can be circuitry (including an antenna) that implements communication using Wi-Fi communication, Bluetooth communication, or the like.

The I/O device 178 can be any device for providing a sensory indication to the second person 160 and/or for allowing the second person 160 in input data to the supervisory system 166. As an example, the I/O device 178 can be a touchscreen or the like, such as utilized by smartphones or tablets. The output device 180 can be any device for providing sensory indications to the second person 160. The sensory indications can include visual, auditory, haptic, or the like. The output device 180 can be any of the examples discussed above for the first output device 126 and the second output device 128. Although an output device 180 is illustrated in FIG. 1, any number of output devices can be incorporated into and/or used with the supervisory device 162, and additionally, any number of input devices and/or I/O devices can be incorporated into and/or used with the supervisory device 162.

A person of ordinary skill in the art will also appreciate that the above-discussed computer systems and devices (e.g., wearable device 104 with analytics system 106, transceiver system 132, recording and analytics server device 144, database device 152, and supervisory device 162 with supervisory system 166) are merely illustrative and are not intended to limit the scope of the disclosure described herein. In particular, the computer systems and devices may include any combination of hardware or software that can perform the indicated operations. Additionally, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations. Further, various components may be located within or remote from the controlled-environment facility 100. For example, the network 142, recording and analytics server device 144, database device 152, and terminal 154 may be located in the controlled-environment facility 100, remote from the controlled-environment facility 100, or any combination thereof, wherein various networks may be implemented to communicatively couple the various components.

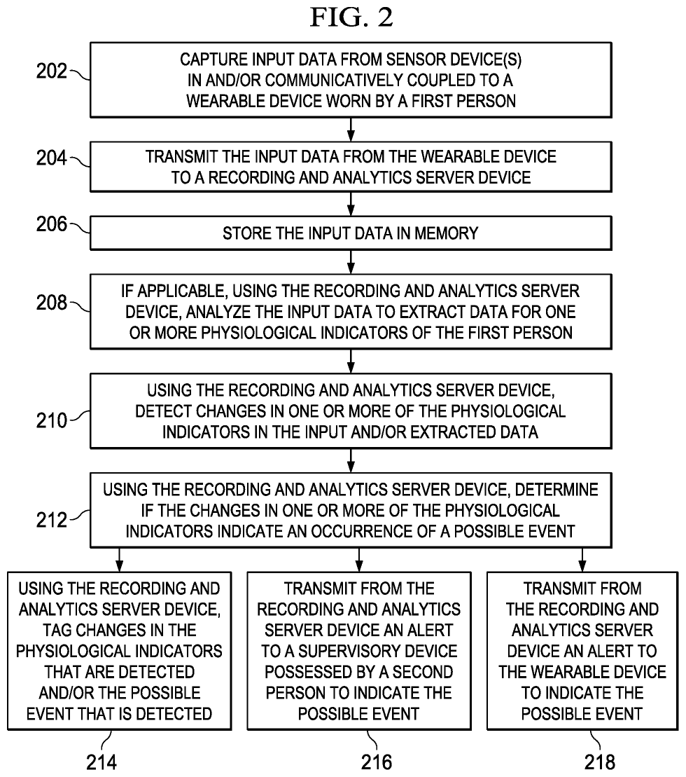

FIG. 2 is a flowchart of an example implementation of a process for detecting a possible event based on one or more change(s) of one or more physiological indicator(s) of a person wearing a wearable device by using data from the wearable device, and for storing and tagging the data to indicate where the change occurred in the data in accordance with some embodiments of the present systems and methods. The process of FIG. 2 is discussed below as operating in the context of the system of FIG. 1, as illustrated. One of ordinary skill in the art will readily understand that the method of FIG. 2 may operate in other environments and systems, such as in modifications of FIG. 1 discussed above or other environments and systems.

In step 202 of FIG. 2, input data is captured from one or more sensor device in and/or communicatively coupled to a wearable device worn by a first person. In the context of FIG. 1, the first sensor device 122 and the second sensor device 124 generate data relating to physiological indicators of the first person 102. More or fewer sensor devices may be used to generate different types of data, for example.

A sensor device (e.g., the first sensor device 122 and the second sensor device 124) can input data into the analytics system 106, where the data is received through an I/O interface (e.g., the first I/O interface 108 and the second I/O interface 110, respectively) and captured by the analytics module operating on the processor 118 of the analytics system 106. The processor 118 can store the data in memory 116 of the analytics system 106 as a cache, buffer, queue, or the like.

The input data captured by the analytics module can be raw data from which physiological indicators can be determined, data that directly indicates physiological indicators, or a combination thereof. For example, a temperature sensor device may output data that directly indicates the temperature of the first user without further processing the data. In another example, a microphone sensor device may output data that includes many sounds or noises in addition to the voice of the first person 102, and additional processing of this data may be used to filter and exclude the additional sounds or noises to isolate the voice of the first person 102.

In step 204, the input data is transmitted from the wearable device to a recording and analytics server device. In the context of FIG. 1, the analytics module operating on the processor 118 can format the input data for transmission, and then, the input data is wirelessly transmitted from the wireless communication component 120 along wireless link 130. The input data is received at the wireless communication component 134 and by the transmission module operating on the processor 136 of the transceiver system 132. The input data can be stored by the transmission module in the memory 138 as a cache, buffer, queue, or the like. The transmission module may then format the input data for transmission. The input data is transmitted from the network interface card 140 of the transceiver system 132, through the network 142, and to the recording and analytics server device 144. The input data is received at the network interface card 146 and by the recording module and/or analytics module operating on the processor 148 of the recording and analytics server device 144. The input data can be stored by the recording module and/or analytics module in the memory 150 as a cache, buffer, queue, or the like.

In step 206, the input data is stored in memory. In the context of FIG. 1, the recording module sends the input data through the network interface card 146 and the network 142 to the database device 152, where the input data is stored in the database operating on the database device 152. The recording module can format the input data for storage in the database of the database device 152. The format of the data may be any acceptable data structure or format.

In step 208, if applicable, the input data is analyzed using a recording and analytics server device to extract data for one or more physiological indicator(s) of the first person. The physiological indicators can include respiratory rate, heart rate, blood pressure, body temperature, voice volume level, speaking rate, voice frequency, or the like. As discussed above, some input data may directly indicate one or more of the physiological indicators. For example, a temperature sensor device may generate data that directly indicates a body temperature of the person wearing the wearable device, which data may be input to the analytics system of the wearable device and transmitted to the recording and analytics server device. Hence, for similar input data, the recording and analytics server device may omit analyzing the input data for a physiological indicator. Other input data may be processed to extract data that directly indicates one or more physiological indicators. For example, a microphone sensor device may generate data that includes many different sounds or noises, which data may be input to the analytics system of the wearable device and transmitted to the recording and analytics server device. This data may be analyzed to extract the data specific to the voice of the person wearing the wearable device, such as by an acceptable speech processing technique which can include filtering the data outside a given frequency range, comparing the data to a stored voice exemplar, or the like. Hence, for similar input data, the recording and analytics server device may analyze the input data to extract data for one or more physiological indicator(s).

In the context of the system of FIG. 1, the analytics module operating on the processor 148 of the recording and analytics server device 144 performs the analysis of the input data to extract data for one or more physiological indicator(s) in some embodiments. The analytics module may access the input data from a cache, buffer, queue, or the like in memory 150 and/or from the database operating on the database device 152. The analytics module may further access biometric exemplars or other information or data to perform the analysis from the memory 150 and/or from the database operating on the database device 152. The analytics module may then perform algorithms upon the input data to extract data for the one or more physiological indicator(s) of the first person 102 wearing the wearable device 104.

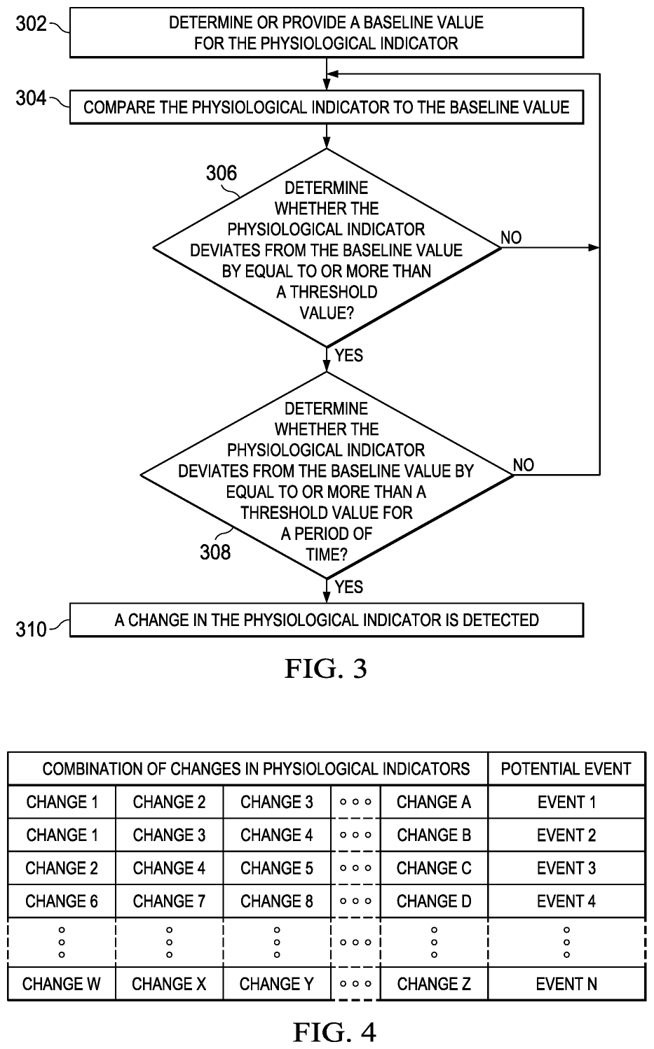

In step 210, changes in one or more of the physiological indicators are detected using the recording and analytics server device. FIG. 3 illustrates an example process for detecting a change in a physiological indicator. In step 302, a baseline value of a given physiological indicator is determined or provided. The baseline can be determined by analyzing the input data and/or the extracted data. For example, an average measurement of a physiological indicator can be determined and used as the baseline for that physiological indicator. The average measurement may be determined from a portion of the input data and/or extracted data, such as a running average of the input data and/or extracted data as that data is received or generated by the recording and analytics server device in real-time. In some examples, the baseline may be set at a predefined threshold and provided in step 302.

In step 304, the physiological indicator is compared to the baseline value of the physiological indicator. In step 306, whether the physiological indicator deviates from baseline value by equal to or more than a threshold value is determined. The threshold value can be a predefined value for a given physiological indicator, can be a value that is in relation to, e.g., an average value of the physiological indicator (such as a percentage), or the like. If the physiological indicator deviates from baseline value by equal to or more than the threshold value, the process continues to step 308, but if not, the process returns to step 304.

In step 308, whether the physiological indicator deviates from baseline value by equal to or more than a threshold value for a period of time is determined. The period of time may be a pre-set period of time or any other period of time. If the physiological indicator deviates from baseline value by equal to or more than the threshold value for the period of time, the process continues to step 310, wherein a change in the physiological indicator is detected, but if not, the process returns to step 304.

By using this process of FIG. 3 to detect a change in a physiological indicator, a change that is thought to be statistically significant can be detected. For example, small deviations and/or short duration deviations may not be indicative of a possible event, and instead, may be false changes. In some embodiments, any change from a baseline can be detected, such as by performing steps 302, 304, and 310 without regard to a threshold value or period of time.

In the context of the system of FIG. 1, the analytics module operating on the processor 148 of the recording and analytics server device 144 can, after extracting data in step 208, if applicable, detect changes in the one or more physiological indicators based on the input data and/or extracted data.

Referring back to FIG. 2, in step 212, whether the changes in the one or more physiological indicators indicate an occurrence of a possible event is determined using the recording and analytics server device. A change in one physiological indicator may not necessarily be indicative of a possible emotional change or other occurrence; however, in some instances, a combination of multiple physiological indicators may indicate a possible event, such as, e.g., a resident being possibly stressed, possibly angry, etc. Various combinations of changes in physiological indicators may be predefined as indicative of a possible emotional change or other occurrence. A list may identify various combinations of changes in physiological indicators that indicate the occurrence of a given event. FIG. 4 is an example list defining combinations of changes of physiological indicators as indicative of potential events. As shown in FIG. 4, various permutations and combinations of changes can be defined for different events. Any number of changes can be used, and any number of events can be predefined.

A statistical approach may be used to determine when a possible event occurs. Any instance of changes in physiological indicators may not be defined explicitly in the list, such as in FIG. 4. For example, a potential event defined in a list as having six different changes in physiological indicators (e.g., increased respiratory rate, increased pulse, increased blood pressure, increased body temperature, increased speaking volume, and increased speaking rate), and in a given instance, five of those six changes are detected. A statistical analysis may be performed to determine the probability that a possible event is occurring even though identity between the detected changes and the list-defined changes does not exist. If the probability exceeds a given amount, such as 80 percent, 90 percent, etc., then the changes in the physiological indicators indicate an occurrence of a possible event. Other techniques may also be used.

In the context of the system of FIG. 1, the analytics module operating on the processor 148 of the recording and analytics server device 144 can determine if the changes in the one or more physiological indicators indicate an occurrence of a possible event. A list defining combinations of changes in physiological indicators to potential events may be stored in the memory 150 in the recording and analytics server device 144 or in the database of the database device 152. The analytics module may access this list during this determination step.

In step 214, the changes in the physiological indicators that are detected and/or the possible event that is determined are tagged in and/or to the corresponding locations (e.g., times) in the input data stored in the memory. In some embodiments, the tag is stored within the data structure of the input data stored in the database of the database device, and in some embodiments, the tag is stored in another data structure with an indicator (e.g., pointer) of where in the input data the change occurred. The tag can also include an indication of a duration that the physiological indicators and/or possible event were in the detected state, such as by including an ending location (e.g., time) of the data. The tag can include an indication of which physiological indicators had the changes that were detected (e.g., by keywords) and information relating to the changes of the physiological indicators (e.g., an amount of variation from the baseline for a given physiological indicator). In the context of the system of FIG. 1, the analytics module can store tags in the memory 150 and/or the database operating on the database device 152.

Once the analytics module completes the analysis of the input data, the input data and the tags are stored in the database operating on the database device 152 and/or other tangible, non-transitory memory medium. This information can be stored in any acceptable data structure. A user, such as at the terminal 154, can access and/or query this information for subsequent investigations and/or data mining, such as to identify sources of various events that occur at the controlled-environment facility.

With the tags, a user, such as at the terminal 154, can query the database operating on the database device 152 to access relevant input data based on the tags. For example, the user can identify a specific tag, and be directed to the beginning of the input data where the change) in physiological indicators and/or event occurred (or earlier to gain context of the changes or event) to review what happened in the input data. This indexing can allow for more efficient searches and identification of information within input data.

Additionally, the second person 160 can access information stored in the database operating on the database device 152 using the supervisory device 162. Using the I/O device 178, e.g., a touchscreen, the second person 160 can use the supervisory module operating on the processor 174 to generate a query of the database operating on the database device 152. The query can be transmitted wirelessly through the wireless communication component 176 along wireless link 156 to the transceiver system 132, where the query is received at the wireless communication component 134 and by the transmission module operating on the processor 136 of the transceiver system 132. The transmission module may then format the query for transmission and transmit the query through the network interface card 140 and the network 142 to the database device 152. The query is received at an interface card on the database device and by the DBMS operating on the processor of the database device 152.

The database is queried by the DBMS, and the DBMS returns data responsive to the query through the network 142 to the transceiver system 132, where the responsive data is received at the network interface card 140 and by the transmission module. The transmission module may then format the responsive data for transmission and wirelessly transmit the responsive data using the wireless communication component 134 along wireless link 156 to the supervisory device 162, where the responsive data is received at the wireless communication component 176 and by the supervisory module. The supervisory module may then output the responsive data through an I/O interface (e.g., the first I/O interface 168 or the second I/O interface 170) to an output device (e.g., the I/O device 178, such as a touchscreen, or the output device 180). The second person may receive and observe real-time or historical data of physiological indicators of an individual or group of individuals, such as including the first person 102, to determine the status of the one or more individuals. This data can be helpful in supervising many individuals, such as many residents (e.g., inmates) of a correctional facility or the like, by one or few individuals.

In step 216, an alert is transmitted from the recording and analytics server device to a supervisory device possessed by a second person to indicate the possible event based on the changes in the physiological indicators that are detected. In the context of FIG. 1, the analytics module operating on the processor 148 of the recording and analytics server device 144 generates an alert when a possible event is determined to occur. The analytics module transmits the alert through the network interface card 146 and the network 142 to the transceiver system 132, where the alert is received at the network interface card 140 and by the transmission module operating on the processor 136 of the transceiver system 132. The transmission module may then format the alert for transmission and wirelessly transmit the alert along wireless link 156 using the wireless communication component 134 to the supervisory device 162, where the alert is received at the wireless communication component 176 and by the supervisory module. The supervisory module may then output the alert through one or more I/O interface(s) (e.g., the first I/O interface 168 or the second I/O interface 170) to one or more output device(s) (e.g., the I/O device 178, such as a touchscreen, or the output device 180). For example, the alert may trigger the supervisory module to output data to a speaker device to generate an auditory alert, to output data to vibrational generator device to generate a haptic alert, and/or to a screen device to generate a visual alert, such as text indicating from which person the change in physiological indicator was detected.

With such an alert, the second person 160 may be alerted to an escalating situation, such as in real-time, because the change in physiological indicator(s) may indicate an increased stress status of the person from which the change in physiological indicator was detected. Hence, the second person 160 may be alerted to a situation earlier than the second person 160 may otherwise perceive from the situation. This can allow the second person 160 to intervene earlier and more easily de-escalate the situation before the situation becomes out of control.

Additionally, the alert may trigger other actions, such as automatically or by intervention of a person. For example, when the alert is sent, the alert may automatically cause soothing music to be played within the controlled-environment facility 100, or the alert may cause, e.g., the second person 160 to cause soothing music to be played within the controlled-environment facility 100. Other actions may be taken.

In step 218, an alert may also be transmitted from the recording and analytics server device to the wearable device to indicate the possible event. In the context of FIG. 1, the analytics module operating on the processor 148 of the recording and analytics server device 144 generates an alert when a possible event is determined to occur, and the analytics module transmits the alert through the network interface card 146 and the network 142 to the transceiver system 132, where the alert is received at the network interface card 140 and by the transmission module operating on the processor 136 of the transceiver system 132. The transmission module may then format the alert for transmission and wirelessly transmit the alert along wireless link 130 using the wireless communication component 134 to the wearable device 104, where the alert is received at the wireless communication component 120 and by the analytics module operating on the processor 118 of the analytics system 106. The analytics module may then output the alert through one or more I/O interface(s) (e.g., the third I/O interface 112 or the fourth I/O interface 114) to one or more output device(s) (e.g., the first output device 126 or the second output device 128). For example, the alert may trigger the analytics module operating on the processor 118 to output data to a speaker device to generate an auditory alert, to output data to a vibrational generator device to generate a haptic alert, and/or to a screen device to generate a visual alert, such as text indicating which physiological indicator in which the change was detected.

With such an alert, the first person 102 may be consciously alerted to a change in his or her state (e.g., stressed and/or excited), such as in real-time. Bringing this alert to the consciousness of the first person 102 may allow the first person 102 to become aware of a potentially problematic situation, and the first person 102 may more easily recognize when to remove himself or herself from the situation. This can allow the first person 102 to avoid escalating situations that might require intervention by, e.g., the second person 160.

In an example application, data from a wearable device worn by an inmate in a correctional facility may be analyzed. The data may be captured during an interaction, such as an interview, interrogation, visitation, or other interaction with staff, faculty, inmates, peers, friends, family, or others.

In an example, audio data captured from the interaction (e.g., by a wearable device) can be analyzed to detect changes in overall and individual voice volumes and speaking rates. Baseline voice volumes and speaking rates may be established using a predetermined threshold or by calculating an average voice volume and speaking rate from the interaction. The voice volumes and speaking rates may be determined using a speech processing algorithm for processing audio data. Such algorithms may detect and analyze the occurrence (e.g., rate and duration) of vowel sounds, consonant sounds, and/or silences. Once a baseline has been determined, a trigger threshold may be set to detect occurrences of speech volume and/or rate that exceed the baseline by a certain amount. These occurrences may be tagged or bookmarked in the audio data. Further, these occurrences can trigger an alert that is sent to a correctional officer's device to alert the correctional officer to a possible situation that needs investigation and intervention. Also, these occurrences can trigger an alert that is sent to the inmate as a warning to avoid confrontational situations or escalating a situation.

Additionally, the rate of changes in the voice volume and/or speech rate may be used to detect occurrences of interest. For example, if a participant's speech increases rapidly, but does not exceed a threshold, such an occurrence may be tagged or bookmarked in the audio data. An investigator may then quickly review events of potential interest in the audio data of the interaction by studying occurrences that have been tagged or bookmarked.

Similarly, other physiological parameters, such as heart rate, blood pressure, breathing rate, or body temperature, may be detected and recorded. Once a baseline has been determined, a trigger threshold may be set to detect occurrences of physiological parameters that exceed the baseline by a certain amount. These occurrences may be tagged or bookmarked in the data that is stored, and may cause alerts to be sent to a correctional officer and the inmate. Due to the tags or bookmarks, an investigator may then quickly review events of potential interest in the stored data by studying occurrences that have been tagged or bookmarked for changes in physiological parameters.

In the context of FIG. 1, the analytics module can store a possible emotional change or other occurrence in the memory 150 and/or the database operating on the database device 152. These occurrences may be stored as tags or bookmarks in a data file or may be stored as a separate file that references times of interest in the data file. The tags or bookmarks may specifically label each occurrence (e.g., loud speech, fast speech, etc.) or may generally indicate that some event occurred.

The data along with the tag or bookmark file may be transmitted from the analytics module to a user on the terminal 154, e.g., through network interface card 146 and network 142. The user, such as an investigator, may analyze the events highlighted by the tags or bookmarks.

Stored tag or bookmark data can be accessed for subsequent investigations, data mining, or the like. In some embodiments, analytics may be performed by a self-contained processor that receives the data via a bus or portable memory device (e.g. a USB flash drive or memory stick, digital versatile disk (DVD), etc.) instead of requiring a direct or remote connection over a network.

In other embodiments, instead of comparing physiological indicators to a baseline value, such as in steps 304 and 306, the physiological indicators of multiple persons may be compared to each other or may be considered as a group. For example, if a plurality of first persons (102) are each wearing wearable devices (104), the physiological indicators, data, or indications output or transmitted from the wearable devices 104 can be analyzed in groups. A group of first persons may include, for example, a group of inmates, prisoners, or detainees within the same pod, cell, wing, or facility. Embodiments may monitor physiological indicators for this group and detect when an average level of a particular physiological indicator is above a baseline value or when the physiological indicator for a predefined number of first persons is above the baseline value. If such a condition occurs, then the system may alert the second person (160) that activity within the pod, cell, wing, or facility associated with the monitored group should be investigated.

In other embodiments, the value of a physiological indicator for one first person (e.g., a particular inmate, prisoner, or detainee) may be selected as the baseline value that is compared to the same physiological indicator for other first persons (e.g., other inmates, prisoners, or detainees) in the same location. This allows the system to detect when a physiological indicator for one person within a group of two or more people is significantly different than other people within that group. A second person 160 (e.g., a correctional officer, guard, or supervisor) may be alerted to monitor the individual first persons (102) having the significantly different physiological indicator.

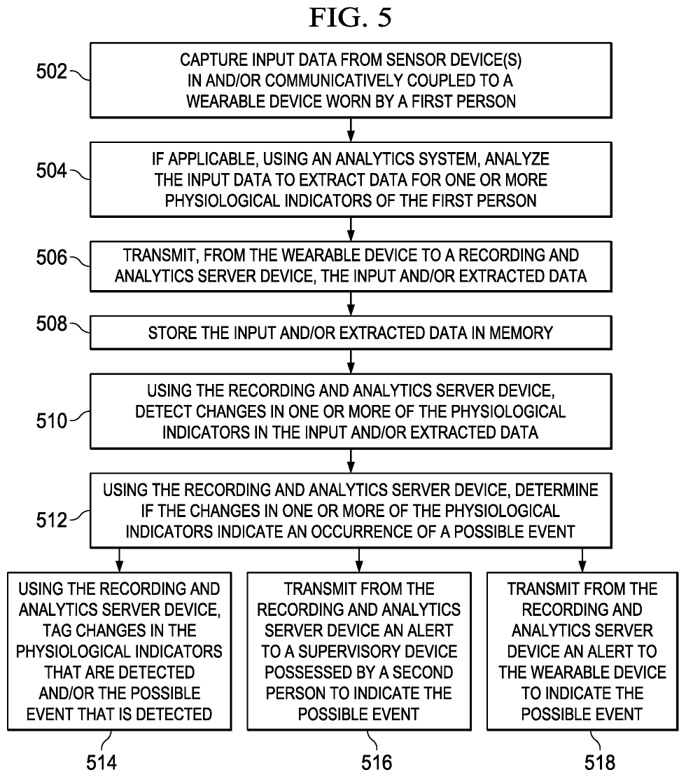

FIG. 5 is a flowchart of another example implementation of a process for detecting a possible event based on one or more change(s) of one or more physiological indicator(s) of a person wearing a wearable device by using data from the wearable device, and for storing and tagging the data to indicate where the change occurred in the data in accordance with some embodiments of the present systems and methods. The process of FIG. 5 is discussed below as operating in the context of the system of FIG. 1, as illustrated. One of ordinary skill in the art will readily understand that the method of FIG. 5 may operate in other environments and systems, such as in modifications of FIG. 1 discussed above or other environments and systems.

In step 502, input data is captured from one or more sensor device(s) in and/or communicatively coupled to a wearable device worn by a first person, like in step 202 of FIG. 2. This step 502 can be performed in the context of FIG. 1 in the same or a similar manner as discussed above with respect to step 202 of FIG. 2.

In step 504, if applicable, the input data is analyzed using an analytics system on the wearable device to extract data for one or more physiological indicator(s) of the first person. Some input data may directly indicate one or more of the physiological indicators. Hence, for that input data, the analytics system may omit analyzing the input data for a physiological indicator. Other input data may be processed to extract data that directly indicates one or more physiological indicators. For example, a microphone sensor device may generate data that includes many different sounds or noises, which may be input to the analytics system of the wearable device and transmitted to the recording and analytics server device. This data may be analyzed to extract the data specific to the voice of the person wearing the wearable device, such as by an acceptable speech processing technique which can include filtering the data outside a given frequency range, comparing the data to a stored voice exemplar, or the like. Hence, for similar input data, the analytics system may analyze the input data to extract data for one or more physiological indicator(s).

In the context of the system of FIG. 1, the analytics module operating on the processor 118 of the analytics system 106 performs the analysis of the input data to detect the physiological indicators in some embodiments. The analytics module may access the input data from a cache, buffer, queue, or the like in memory 116. The analytics module may further access biometric exemplars or other information or data to perform the analysis from the cache, buffer, queue, or the like in memory 116 and/or from the database operating on the database device 152. The analytics module may then perform algorithms upon the input data to extract data for the physiological indicators of the first person 102 wearing the wearable device 104. By performing this analysis at the wearable device 104, less data may be transmitted from the wearable device 104, as will become evident in the following discussion. This can be beneficial in bandwidth limited applications.

In step 506, the input and/or extracted data is transmitted from the wearable device to a recording and analytics server device. This step 506 can be performed in the context of FIG. 1 in the same or a similar manner that the input data was transmitted as discussed above with respect to step 204 of FIG. 2.

In step 508, the input and/or extracted data is stored in memory. This step 508 can be performed in the context of FIG. 1 in the same or a similar manner that the input data was stored as discussed above with respect to step 206 of FIG. 2.

In step 510, changes in one or more of the physiological indicators are detected using the recording and analytics server device. In step 512, whether the changes in one or more of the physiological indicators indicate an occurrence of a possible event is determined using the recording and analytics service device. In step 514, changes in the physiological indicators that are detected and/or the possible event are tagged in and/or to the corresponding locations in the input and/or extracted data stored in the memory. In step 516, an alert is transmitted from the recording and analytics server device to a supervisory device possessed by a second person to indicate the possible event based on the changes in the physiological indicators that are detected. In step 518, an alert may also be transmitted from the recording and analytics server device to the wearable device to indicate the possible event. These steps 510, 512, 514, 516, and 518 can be performed in the context of FIG. 1 in the same or a similar manner as discussed above with respect to steps 210, 212, 214, 216, and 218, respectively, of FIG. 2.

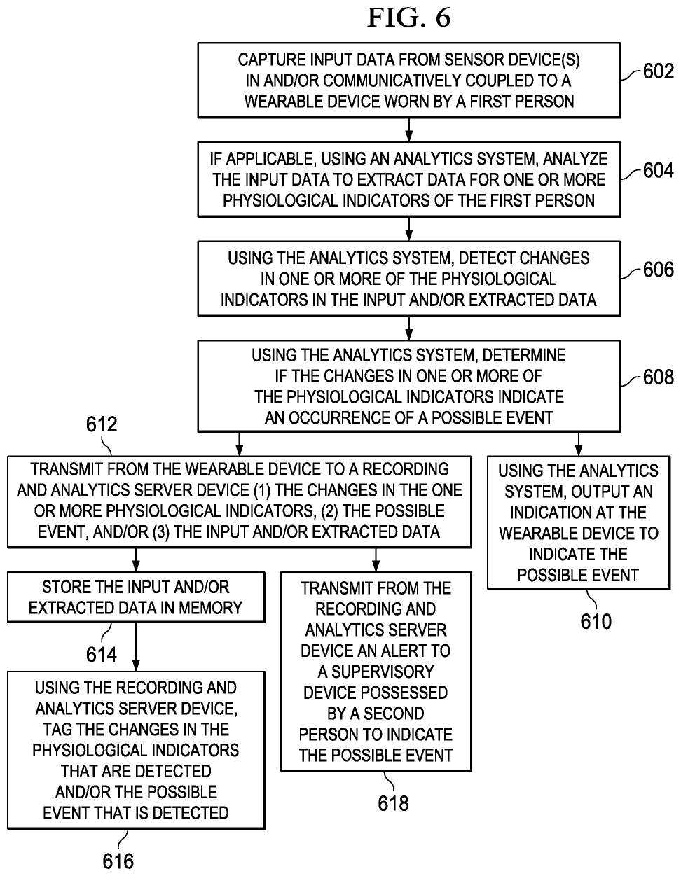

FIG. 6 is a flowchart of a further example implementation of a process for detecting a possible event based on one or more change(s) of one or more physiological indicator(s) of a person wearing a wearable device by using data from the wearable device, and for storing and tagging the data to indicate where the change occurred in the data in accordance with some embodiments of the present systems and methods. The process of FIG. 6 is discussed below as operating in the context of the system of FIG. 1, as illustrated. One of ordinary skill in the art will readily understand that the method of FIG. 6 may operate in other environments and systems, such as in modifications of FIG. 1 discussed above or other environments and systems.

In step 602, input data is captured from one or more sensor device(s) in and/or communicatively coupled to a wearable device worn by a first person, like in step 202 of FIG. 2. This step 602 can be performed in the context of FIG. 1 in the same or a similar manner as discussed above with respect to step 202 of FIG. 2.

In step 604, if applicable, the input data is analyzed using an analytics system on the wearable device to extract data for one or more physiological indicator(s) of the first person. Some input data may directly indicate one or more of the physiological indicators. This step 604 can be performed in the context of FIG. 1 in the same or a similar manner as discussed above with respect to step 504 of FIG. 5.

In step 606, changes in one or more of the physiological indicators are detected using the analytics system in the wearable device. In some embodiments, the process of FIG. 3 may be used to detect a change in a physiological indicator that may be, e.g., statistically significant, and in some embodiments, any change from a baseline can be detected, such as by performing steps 302, 304, and 310 without regard to a threshold value or period of time.

In the context of the system of FIG. 1, the analytics module of the analytics system 106 can, after extracting data in step 604, if applicable, detect changes in the one or more physiological indicators based on the input data and/or extracted data.

In step 608, whether the changes in the one or more physiological indicators indicate an occurrence of a possible event is determined using the analytics system. A list defining various combinations of changes in physiological indicators to potential events and a statistical technique can be used as discussed above with respect to step 212 of FIG. 2; although other techniques may also be used.

In the context of the system of FIG. 1, the analytics module operating on the processor 118 of the analytics system 106 can determine if the changes in the one or more physiological indicators indicate an occurrence of a possible event. A list defining combinations of changes in physiological indicators to potential events may be stored in the memory 116 in the analytics system 106 or in the database of the database device 152, which may be accessed by the analytics module using the wireless communication component 120 and through the transceiver system 132 and network 142.

In step 610, an indication is output using the analytics system of the wearable device to indicate the possible event. In the context of FIG. 1, the analytics module operating on the processor 118 of the analytics system 106 outputs the indication through one or more I/O interface(s) (e.g., the third I/O interface 112 or the fourth I/O interface 114) to one or more output device(s) (e.g., the first output device 126 or the second output device 128). For example, the alert may trigger the analytics module operating on the processor 118 to output data to a speaker device to generate an auditory alert, to output data to a vibrational generator device to generate a haptic alert, and/or to a screen device to generate a visual alert, such as text indicating which physiological indicator in which the change was detected.

In step 612, the change in the one or more physiological indicators, the possible event, and/or the input and/or extracted data are transmitted from the wearable device to a recording and analytics server device. This step 610 can be performed in the context of FIG. 1 in a similar manner that the input data was transmitted as discussed above with respect to step 204 of FIG. 2.

In step 614, the input and/or extracted data is stored in memory. This step 612 can be performed in the context of FIG. 1 in the same or a similar manner that the input data was stored as discussed above with respect to step 206 of FIG. 2.

In step 616, the changes in the physiological indicators that are detected and/or the possible event are tagged in and/or to the corresponding locations in the input and/or extracted data stored in the memory. In step 616, an alert is transmitted from the recording and analytics server device to a supervisory device possessed by a second person to indicate the possible event. These steps 616 and 618 can be performed in the context of FIG. 1 in the same or a similar manner as discussed above with respect to steps 214 and 216, respectively, of FIG. 2.

An example embodiment includes a method comprising the steps of: using an analytics module operating on at least one processor, receiving first data indicative of multiple physiological indicators of a first person, wherein the first data is transmitted from a wearable device worn by the first person; detecting changes in at least two of the multiple physiological indicators from the first data; determining an occurrence of a possible event based on the changes in the at least two of the multiple physiological indicators, the determining the occurrence of the possible event comprising correlating the changes in the at least two of the multiple physiological indicators to pre-defined combinations of changes in corresponding physiological indicators; and transmitting an alert when the occurrence of the possible event is determined. The method may further comprise using a recording module operating on at least one processor, storing the first data in a database operating on a database device.

The alert may be transmitted to the wearable device or to a supervisory device of a second person, the first person being different from the second person. The multiple physiological indicators may include a combination of at least two of: respiratory rate, heart rate, blood pressure, body temperature, voice volume level, speaking rate, and voice frequency. The at least one processor on which the analytics module operates may be in a server device.

Detecting the changes in the at least two of the multiple physiological indicators may include, for each of the at least two of the multiple physiological indicators: determining a baseline of the respective physiological indicator from the first data; and determining when the respective physiological indicator deviates from the baseline by at least a threshold value. Detecting the changes in the at least two of the multiple physiological indicators may include extracting second data from the first data, the second data being indicative of at least one of the multiple physiological indicators, the detecting the changes including detecting a change in the at least one of the multiple physiological indicators from the second data.

The method may further comprise using a recording module operating on at least one processor to store the first data in a database operating on a database device and to tag the first data in the database to indicate locations in the first data where the changes in the at least two of the multiple physiological indicators were detected, the occurrence of the possible event, or a combination thereof.

In another embodiment, a system comprises a wearable device having sensor devices, the wearable device and sensor devices being operable to generate first data indicative of multiple physiological indicators of a first person wearing the wearable device, the wearable device further comprising a first wireless communication component operable to wirelessly transmit a first signal comprising the first data; a wireless access point comprising a second wireless communication component operable to receive the first signal; and an analytics server device communicatively coupled to the wireless access point, the analytics server device comprising a first analytics module operable on at least one processor, the first analytics module being operable to receive the first data, to detect changes in the multiple physiological indicators of the first person from the first data, and to determine an occurrence of a possible event based on the changes in the multiple physiological indicators.

The system may further comprise a database device having a database management system operable on at least one processor and having a database memory for storing a database, the analytics server device being communicatively coupled to the database device, the analytics server device further having a recording module operable on at least one processor, the recording module being operable to store the first data in the database memory and to store a tag in the database, the tag indicating locations in the first data where the changes in the multiple physiological indicators occurred, the occurrence of the possible event, or a combination thereof.

The system may further comprise a supervisory device comprising a third wireless communication component operable to receive a second signal, the second wireless communication component being operable to wirelessly transmit the second signal, the first analytics module being operable to transmit to the supervisory device an alert upon determining the occurrence of the possible event, the alert being transmitted through the second signal.

The first wireless communication component may be operable to receive a second signal, the second wireless communication component being operable to wirelessly transmit the second signal, the first analytics module being operable to transmit to the wearable device an alert upon determining the occurrence of the possible event, the alert being transmitted through the second signal.

The wearable device may have a second analytics module operable on at least one processor, at least one of the sensor devices being operable to generate second data, the second analytics module being operable to extract at least some of the first data from the second data.

The sensor devices may be operable to generate the first data, the first analytics module being operable to extract second data from the first data, the first analytics module being operable to detect changes in at least some of the multiple physiological indicators of the first person using the second data.

In a further embodiment, a non-transitory computer-readable storage medium has a computer program embodied thereon, the computer program comprising program code instructions for receiving first data generated from a wearable device worn by a first person, the first data being indicative of physiological indicators of the first person; program code instructions for detecting changes in the physiological indicators based on the first data; program code instructions for determining when the changes in the physiological indicators indicate an occurrence of a possible event; and program code instructions for generating and transmitting an alert when the occurrence of the possible event is indicated. The non-transitory computer-readable storage medium may be any appropriate electronic storage device, memory, RAM, SRAM, SDRAM, nonvolatile memory, or Flash memory, for example.

The program code instructions for determining when the changes in the physiological indicators indicate the occurrence of the possible event may include: program code instructions for accessing a list identifying combinations of potential changes in physiological indicators with potential events; and program code instructions for correlating the changes in the physiological indicators to the combinations of potential changes, the occurrence of the possible event corresponding to one of the potential events based on correlating the changes in the physiological indicators to the combinations of potential changes.

The computer program may further comprise program code instructions for extracting second data from the first data, the second data being indicative of at least some of the physiological indicators, the program code instructions for detecting the changes in the physiological indicators using the second data.

The program code instructions for detecting the changes in the physiological indicators may include: program code instructions for determining a baseline for each the physiological indicators based on the first data; and program code instructions for determining when each of the physiological indicators deviates from the respective baseline by at least a respective threshold value.

The computer program may further comprise: program code instructions for storing the first data to memory; and program code instructions for storing a tag to the memory, the tag indicating a location in the first data where the changes occurred, the possible event occurred, or a combination thereof.

Although the present embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from this disclosure, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method comprising:
using an analytics module operating on at least one processor;
receiving data from a plurality of individuals of a group, wherein the data received from each respective individual is indicative of a plurality of physiological indicators of the respective individual, and wherein the data is transmitted from a wearable device worn by the respective individual;
determining, based on the received data, a baseline for a first physiological indicator of a first individual of the group;
comparing data received from other individuals in the group for the same physiological indicator as the first physiological indicator against the baseline of the first individual;
determining, based on the comparisons, whether the first physiological indicator of the first individual deviates from the physiological indicators of the other individuals in the group; and
transmitting a first alert to a supervisory device when the deviation is identified.

2. The method of claim 1, wherein a second alert is transmitted to the wearable device worn by the first individual.

3. The method of claim 1, wherein the first alert identifies the first individual.

4. The method of claim 1, wherein the physiological indicators include: respiratory rate, heart rate, blood pressure, body temperature, voice volume level, speaking rate, and voice frequency.

5. The method of claim 1 further comprising using a recording module operating on at least one processor, storing the received data in a database operating on a database device.

6. The method of claim 1, further comprising:
determining a baseline for the physiological indicators received from each individual of the group.

7. (canceled)

8. The method of claim 1 further comprising:
using a recording module operating on at least one processor:
storing the data in a database operating on a database device; and
tagging the data in the database to indicate locations in the data where the deviation is identified.

9. The method of claim 1, wherein the at least one processor on which the analytics module operates is in a server device.

10. A system comprising:
a plurality of wearable devices comprising sensor components, the sensor components operable to generate data indicative of physiological indicators of an individual wearing the respective wearable device of the plurality of wearable devices, the plurality of wearable devices each further comprising a wireless communication component operable to wirelessly transmit the data generated by the sensor components;
a wireless access point comprising a wireless transceiver operable to receive the data transmitted by the respective wearable devices; and
an analytics server device communicatively coupled to the wireless access point, the analytics server device comprising a first analytics module operable on at least one processor, the first analytics module being operable to receive the data, and further operable to determine, based on the received data, a baseline for a first physiological indicator of a first individual of a group, and further operable to compare data received from other individuals in the group for the same physiological indicator as the first physiological indicator against the baseline of the first individual, and further operable to determine, based on the comparisons, whether the first physiological indicator of the first individual deviates from the physiological indicators received from an other of the plurality of wearable devices worn by the other individuals in the group, and further operable to transmit a first alert to a supervisory device when the deviation is identified.

11. The system of claim 10 further comprising a database device having a database management system operable on at least one processor and having a database memory for storing a database, the analytics server device being communicatively coupled to the database device, the analytics server device further having a recording module operable on at least one processor, the recording module being operable to store the data in the database memory and to store a tag in the database, the tag indicating locations in the data where the deviation occurred.

12. The system of claim 10 wherein the first alert identifies the first individual.

13. The system of claim 10, wherein the first analytics module is further operable to transmit a second alert to the wearable device of the first individual upon identifying the deviation.

14. (canceled)

15. (canceled)

16. A non-transitory computer-readable storage medium having a computer program embodied thereon, the computer program comprising:
program code instructions for receiving data from a plurality of individuals of a group, wherein the received data is transmitted from a wearable device worn by each respective individual, and wherein the data received from each wearable device is indicative of physiological indicators of the individual wearing the wearable device;
program code instructions for determining, based on the received data, a baseline for a first physiological indicator of a first individual of the group;
program code instructions for comparing data received from other individuals in the group for the same physiological indicator as the first physiological indicator against the baseline of the first individual;
program code instructions for determining, based on the comparisons, the first physiological indicator of the first individual in the group that deviates from the physiological indicators of the other individuals in the group; and
program code instructions for generating and transmitting a first alert to a supervisory device when the deviation is identified.

17. The non-transitory computer-readable storage medium of claim 16, wherein the first alert specifies the location of the first individual.

18. The non-transitory computer-readable storage medium of claim 16, wherein the computer program further comprises program code instructions for extracting emotional state data from the data, the emotional state data being indicative of an emotional state for each respective individual and wherein the compared data comprises the extracted emotional state data.

19. The non-transitory computer-readable storage medium of claim 16, wherein the program code instructions for detecting the deviation in the physiological indicators includes:
program code instructions for determining a baseline for the physiological indicators for each individual in the group, wherein the compared data comprises the baselines.

20. The non-transitory computer-readable storage medium of claim 16, wherein the computer program further comprises:
program code instructions for storing the first data to memory; and
program code instructions for storing a tag to the memory, the tag indicating a location in the data where the deviation is identified.

21. (canceled)

22. The system of claim 10, wherein the deviation is identified in comparison to an average of the physiological indicators received for each of the respective individuals.

23. The non-transitory computer-readable storage medium of claim 16, wherein the first alert comprises a type of the identified deviation.

24. The method of claim 1 wherein the deviation is identified in comparison to an average of the physiological indicators received for each of the respective individuals.
